(19) United States
(12) Patent Application Publication
(10) Pub. No.: US 2002/0080261 A1
(43) Pub. Date: Jun. 27, 2002

(54) Image processing apparatus and image sensing device

(75) Inventors: Masahiro Kitamura, Sakai-Shi (JP); Yasuhiro Morimoto, Takatsuki-Shi (JP); Shinichi Fujii, Osaka-Shi (JP)

Correspondence Address: SIDLEY AUSTIN BROWN & WOOD LLP, 717 NORTH HARWOOD, SUITE 3400, DALLAS, TX, 75201, US

(73) Assignee: MINOLTA CO., LTD.

(21) Appl. No.: 09/941,816

(22) Filed: Aug. 29, 2001

(30) Foreign Application Priority Data
Sep. 5, 2000 (JP) 2000-268813

(51) Int. Cl. H04N 5/232

(52) U.S. Cl. 348/349

(57) ABSTRACT

The image sensing device or image processing apparatus has a synthesizing capability enabling the device or apparatus to perform blur control using a specified amount of blur and to prepare a blur-controlled image, as well as a blur-controlled image processing capability enabling the device or apparatus to carry out processes other than blur control on the prepared blur-controlled image and to change the degree of processing in accordance with the amount of blur.

This application is based on the application No. 2000-268813 filed in Japan, the content of which is hereby incorporated by reference.

### BACKGROUND OF THE INVENTION

1. Field of the Invention

The present invention relates to an image processing apparatus that prepares blur-controlled images from images captured using an image sensing device, such as a digital camera, and an image sensing device incorporating this image processing feature.

2. Description of the Related Art

Digital cameras have been proposed that capture multiple images focusing on the foreground or background, for example, and having different focal lengths, and that prepare from these multiple images blur-controlled images in which the degree of blurring of the objects, such as the foreground and background, is adjusted.

A blur-controlled image may further undergo other processes, such as image compression, which is performed in order to store the image in a recording medium, coring or aperture control.

However, conventionally, the image compression or other processes that are performed following blur control is carried out independently of blur control. Consequently, where the amount of blur that is specified during blur control is large, for example, even though the image is only minimally affected even if the compression ratio is increased, the image is compressed using a fixed compression ratio, and processing using an appropriate compression ratio has not been available.

This is true not only with regard to image compression, but also with the processes of coring and aperture control.

An article entitled ‘Acquisition of an All-Focused Image by the Use of Multiple Differently Focused Images’, authored by Kodama, Aizawa and Hatori (Electronic Information Communication Association newsletter J80-DII, 9, pp. 2,298-2,307, July, 1997) discloses a construction in which a pan-focus image is prepared using multiple images, but this construction does not include changing the degree of image compression, coring or aperture control based on the amount of blur of the image.

An object of the present invention is to provide an image processing apparatus and an image sensing device that can favorably perform processes other than blur control.

### SUMMARY OF THE INVENTION

In order to resolve the problems identified above, the image processing apparatus comprises a synthesizer for generating a blur controlled image with an adjusted blur amount from multiple images having different focal lengths; an image processor for performing processes other than blur control on the blur-controlled image prepared by the synthesizer; and a changer for changing a degree of the processes other than blur control in accordance with the amount of blur.

Furthermore, in order to resolve the problems identified above, the image sensing device comprises an image sensor for capturing multiple images having different focal lengths; a synthesizer for generating a blur controlled image with an adjusted blur amount from multiple images captured by the image sensor; an image processor for performing processes other than blur control on the blur-controlled image prepared by the synthesizer; and a changer for changing a degree of the processes other than blur control in accordance with the amount of blur.

### BRIEF DESCRIPTION OF THE DRAWINGS

In the following description, like parts are designated by like reference numbers throughout the several drawings.

FIG. 1 is an external perspective view showing a digital camera in which the image sensing device pertaining to one embodiment of the present invention is applied;

FIG. 2 is a rear elevation of the digital camera;

FIG. 3 is a drawing to explain the image synthesis process;

FIG. 4 is a block diagram showing the electronic construction of the digital camera;

FIG. 5 is a drawing to explain γ-correction;

FIG. 6 is a graph to explain one example of the relationship between the amount of blur and the γ-correction value;

FIG. 7 is a graph showing the relationship between the frequency and the output in the coring process;

FIG. 8 is a graph showing the relationship between the amount of blur and the cut-off frequency a2 in the coring process;

FIG. 9 is a block diagram of the aperture control process;

FIG. 10 is a graph showing the relationship between the amount of blur and the amplification ratio G in the aperture control process; and

FIG. 11 is a graph showing the relationship between the amount of blur and the compression ratio in the image compression process.

### PREFERRED EMBODIMENT OF THE INVENTION

An embodiment of the present invention is explained below with reference to the drawings.

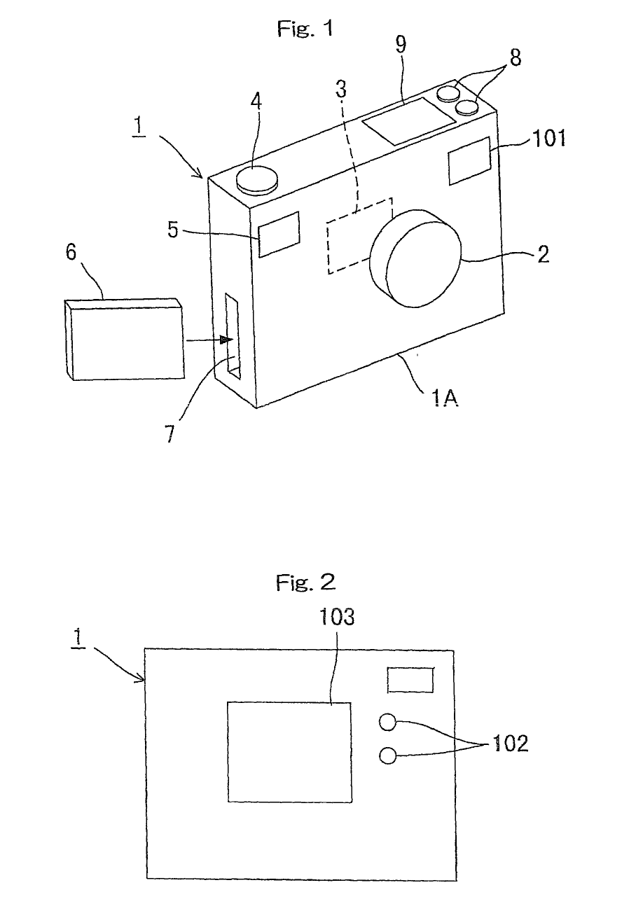

FIGS. 1 and 2 are an perspective external view and a rear elevation of a digital camera, which comprises the image sensing device that incorporates the image processing feature pertaining to one embodiment of the present invention.

In FIGS. 1 and 2, 1 is a digital camera, and on the front surface of the camera body 1A are located a photo-taking lens 2, a finder window 5, and a distance measuring window 101. Inside the camera body is located a CCD 3, which is a photo-sensing element that performs photoelectric conversion of the captured optical image, and which is located in the light path of the photo-taking lens 2. Furthermore, on the top surface of the camera body 1A are located a shutter release button 4, image capture mode setting keys 8, and a liquid crystal display panel 9. In these drawings, the number 6 indicates a recording medium in which the image data is stored, and the number 7 indicates a recording medium insertion inlet formed in the side of the camera body 1A.

The image capture mode setting keys 8 are used by the user to (i) specify an exposure condition such as aperture priority or shutter speed priority, (ii) change to macro photo-taking or (iii) specify a zoom ratio, while viewing the liquid crystal display panel 9.

On the rear surface of the camera body 1A are located, as shown in FIG. 2, image processing mode setting keys 102 and a liquid crystal monitor 103, which functions as a viewfinder. The image processing mode setting keys 102 are used by the user in order to specify the image synthesis mode through which a pan-focus image or blur-controlled image is prepared, or to specify the amount of blur while viewing the liquid crystal monitor 103.

In this digital camera 1, the image data incorporated by the CCD 3 may be recorded in the recording medium 6 in the same manner as in a regular digital camera. Further, it has a feature to prepare a pan-focus image and a blur control feature to prepare a blur-controlled image from multiple images having different focal lengths. The feature to prepare blur-controlled images may be activated by operating the image processing mode setting keys 102 and setting the blur control mode.

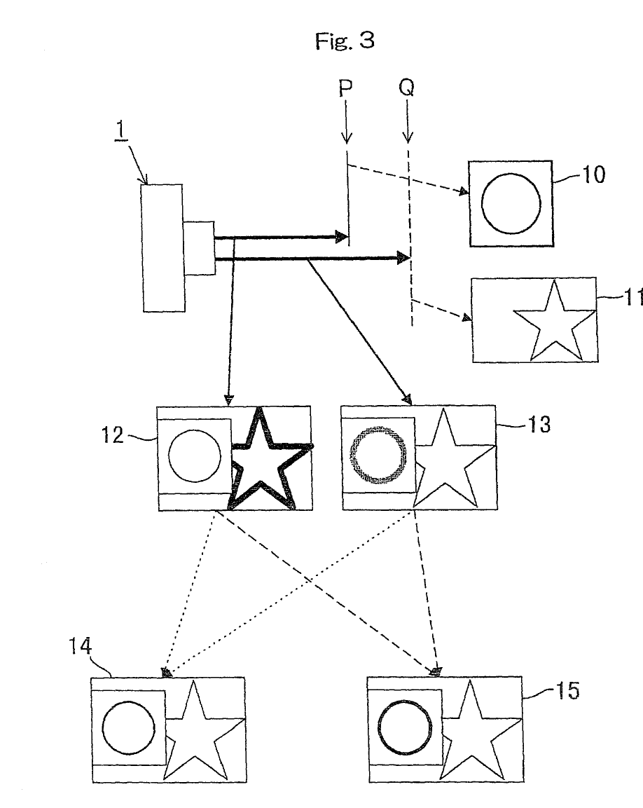

FIG. 3 is a drawing to explain the use of the digital camera 1 when the blur control mode is activated. It shows a scene in which far and near objects are competing with each other, i.e., objects 10 and 11 exist on the P and Q planes, respectively. For purposes of simplification, the objects 10 and 11 comprise flat surface charts. 12 is an image captured with the focus on the P plane. The circle in the chart 10, which comprises the foreground, is clear, while the star in the chart 11, which comprises the background, is blurred. 13 is an image captured with the focus on the Q plane. The circle in the chart 10, the foreground, is blurred, and the star in the chart 11, the background, is clear.

In the image synthesis mode, the images 14 and 15 are prepared from these two images 12 and 13. The image 14 is a so-called pan-focus image in which the focus is on both the objects 10 and 11. The image 15 is a blur controlled image in which the focus is kept on the chart 11, the background, and the degree of blur of the chart 10, the foreground, is emphasized than in the image 13.

As described above, using this digital camera 1, a pan-focus image and a blur-controlled image in which the degree of blur of the foreground or background is freely changed may be obtained from two or more images captured of the same scene but based on different focal planes (focal point positions).

In addition, in the above explanation, the objects were distributed at two different locations, i.e., the foreground and background, and therefore the number of images captured was two, but there may be three different locations, i.e., the foreground, intermediate ground and background, or more, and the number of images may vary accordingly as well.

When the image synthesis mode is specified and the setting of the degree of blur is carried out using the image processing mode setting keys 102, selectable amounts of blur, i.e., ‘focus on foreground, very blurry background’, ‘focus on foreground, slightly blurry background’, ‘very blurry foreground, focus on background’, ‘slightly blurry foreground, focus on background’ and ‘pan-focus’ are displayed in the liquid crystal monitor 103, so that the user may select the desired setting.

For example, in order to obtain the image 14, ‘pan-focus’ should be selected, and in order to obtain the image 15, ‘very blurry foreground, focus on background’ should be selected.

The principle of blur control is disclosed in U.S. Pat. No. 5,124,842 and Japanese Laid-Open Patent Application Hei 10-108057, and resides in the public domain. Therefore, it will not be explained here.

The present invention relates to changing the degree of processing for processes other than blur control in accordance with the amount of blur specified in the blur control process when such other processing is performed on the blur-controlled image prepared through blur control.

Such other processing comprises a process in which the compression ratio is changed when a blur-controlled image is compressed, for example. An image captured by a digital camera is compressed using the JPEG or similar method where the user so desires. When this occurs, if the user has specified ‘focus on foreground, very blurry background’, even if a higher compression ratio than normal is used for the compression, little image deterioration is caused by the compression. Therefore, in this digital camera, the compression ratio is varied in accordance with the ‘amount of blur’ specified by the user.

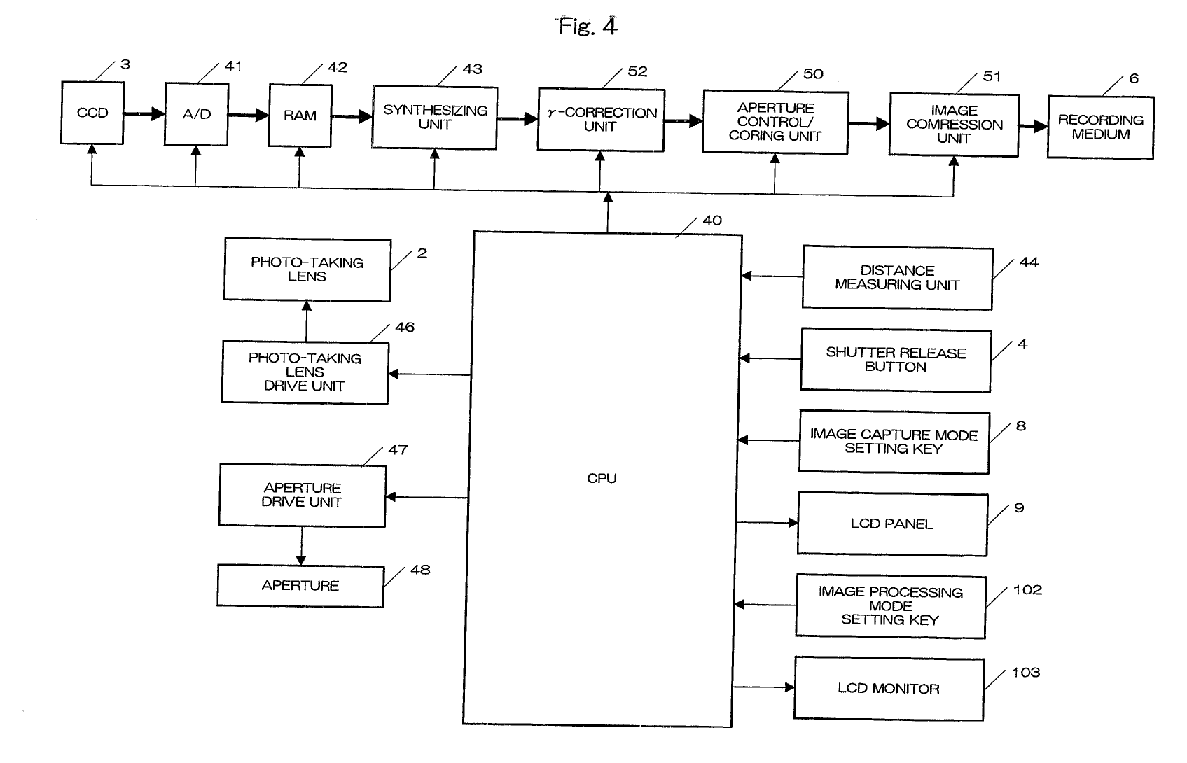

FIG. 4 is a block diagram showing the construction of the digital camera 1. The thin arrow indicates the flow of control data, while the thick arrow indicates the flow of image data.

The number 40 indicates a CPU, which (i) stores the image capture conditions when the shutter release button 4 is pressed and the status of the image capture mode setting keys 8, and (ii) causes the exposure conditions, etc. to be displayed in the liquid crystal display panel 9. Furthermore, the CPU 40 drives the photo-taking lens 2 via the photo-taking lens drive unit 46 based on the distance measurement result from the distance measuring unit 44, such that the lens is in focus with regard to an appropriate object. In addition, the CPU 40 controls the aperture 48 via the aperture drive unit 47. It also carries out comprehensive control of the entire digital camera 1.

The analog image signals from the CCD 3 are converted into digital image data by the A/D converter 41, and the digital data is temporarily stored in the image memory (RAM) 42. The CPU 40 records in the recording medium 6 the image data read from the image memory (RAM) 42.

The synthesizing unit 43 prepares, from among multiple images having different focal lengths, an image that is in accord with the specified image processing mode. Such image may be a pan-focus image or blur-controlled image.

The γ-correction unit 52 performs the process of γ-correction, which is described below, with respect to the blur-controlled image prepared by the synthesizing unit 43, in accordance with the amount of blur. The aperture control/coring unit 50 performs the processes of aperture control and of coring, which are described below, on the γ-corrected image in accordance with the amount of blur. The image compression unit 51 compresses the image, which has undergone γ-correction, aperture control and coring, in accordance with the amount of blur.

The operation followed when photo-taking is carried out using the digital camera 1 shown in FIG. 4, in which the blur control mode is activated, will be explained below.

First, the user makes a selection via the image capture mode setting keys 8 regarding aperture priority, shutter speed priority, etc. The operation is identical to that performed in normal image capture mode to this point. The user then selects photo-taking with blur control, as well as an amount of blur, via the image processing mode setting keys 102. When these settings regarding the camera are completed, the user confirms the photo object and presses the shutter release button 4. The distance measuring unit 44 then measures the object distance. Based on the result of this distance measurement, the photo-taking lens drive unit 46 drives the photo-taking lens 2 such that the lens is in focus with regard to an appropriate object. The aperture drive unit 4 then sets the aperture to an appropriate value. Charge accumulation by the CCD 3 takes place, and the image data is read out. The image data thus read out is converted into digital data by the A/D converter 41 using the pipeline method and is temporarily stored in the RAM 42.

The above operation is repeated for the number of images necessary to perform the process of image synthesis, and the image data is stored in the RAM 42. The repeated photo-taking may be automatically performed by the digital camera or manually by the user. When the necessary number of images is stored in the RAM 42, image processing is carried out by the image p recessing unit 43. Subsequently, γ-correction is performed by the γ-correction unit 52 in accordance with the amount of blur. This process of γ-correction is described in detail below. Furthermore, aperture control and coring are performed by the aperture control/coring unit 50 in accordance with the amount of blur. These processes of aperture control and coring are described in detail below. When the image is completed, it is compressed by the image compression unit 51 in accordance with the amount of blur. The compressed image is recorded in the image medium 6. This is the sequence followed when a blur-controlled image is prepared.

The process of γ-correction will now be explained.

‘γ-correction’ comprises nonlinear conversion of the b rightness value of the captured image. This nonlinear conversion process is required for the following reason.

Generally, an image captured using a digital camera is viewed in the monitor. However, the output value does not have a linear correspondence to the input value in the monitor. In other words, if the image captured by the digital camera is input to the monitor as is, the displayed image is not identical to the image captured by the user. Therefore, processing is performed to the image captured by a digital camera in order to offset the nonlinear processing carried out by the monitor. This is ‘γ-correction’.

FIG. 5 shows the relationships among the brightness of the object, γ-correction performed by the digital camera, γ-conversion performed by the monitor, and the image output to the monitor. In this drawing, the first quadrant shows the relationship between the brightness of the light reflected by the object (the OA axis) and the amount of light that strikes the camera (the OB axis). The second quadrant shows the relationship between the post-A/D conversion output value (the OB axis) from the CCD sensor and the output image (the OC axis). Here, nonlinear conversion is performed in accordance with the γ-correction curve shown in the drawing. The third quadrant shows the relationship between the input image (the OC axis) to the monitor and the brightness of the light emitted by the monitor (the OD axis). Finally, the fourth quadrant shows the relationship between the brightness of the monitor emission (the OD axis) and the brightness of the monitor screen (the OA axis), i.e., the image that the user actually observes. As can be seen from this drawing, by performing γ-correction in the second quadrant, the linear correspondence between the captured image and the image displayed in the monitor is maintained.

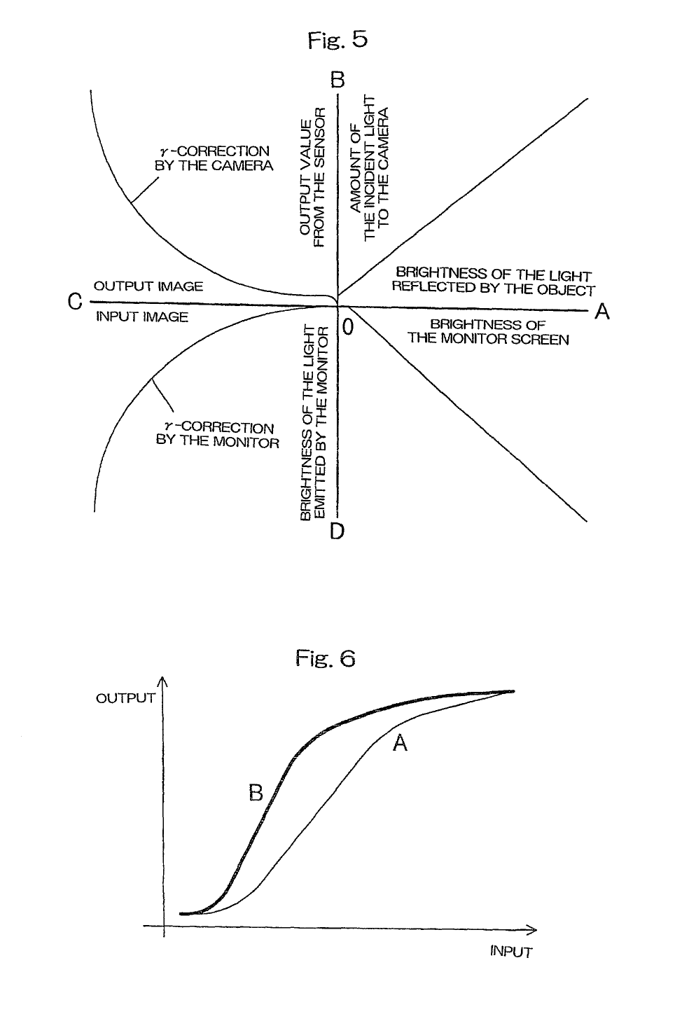

FIG. 6 shows one example of the relationship between the γ-correction value and the amount of blur. The curve A shown by the thin line comprises the γ-correction curve (γ-correction value) when no blur control is performed. This curve rises gently in order to render the noise components imperceptible. However, where the user wants to emphasize blurring in the blur-controlled image, the γ-correction curve is changed to the curve comprising the thick line B. When the rise of the γ-correction curve is sharp, as in the thick line B, the image can be made clear with a sharp contrast. Where blurring is emphasized, because the noise becomes blurred and appears only in a dull fashion, the noise is barely perceptible.

As explained above, by changing the γ-correction in accordance with the amount of image blur, a clear image may be obtained in which the noise components are de-emphasized.

The process performed by the aperture control/coring unit 50 will now be explained.

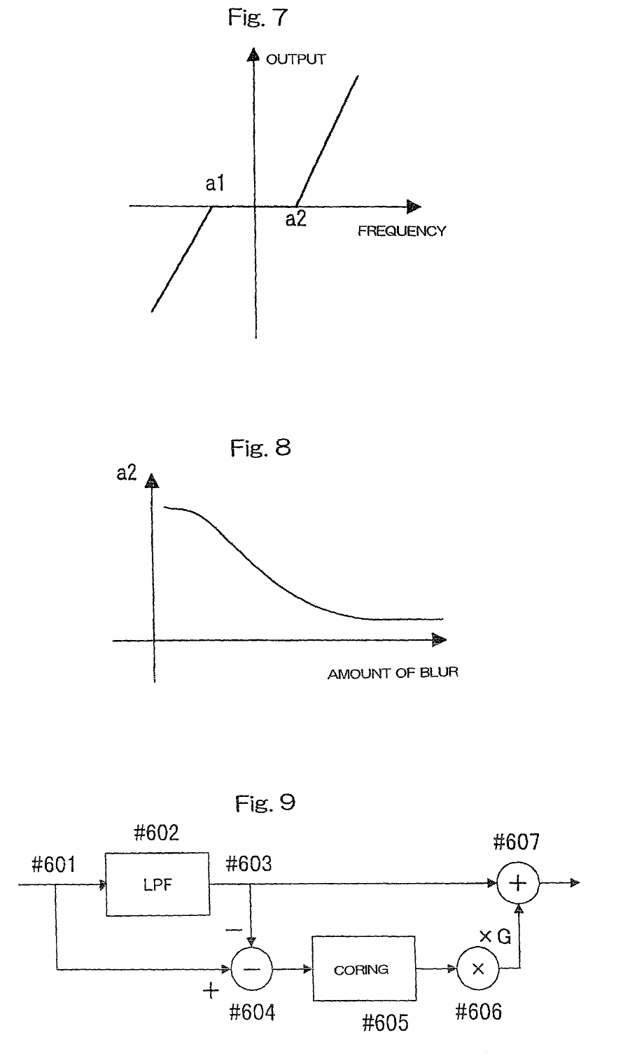

‘Coring’ is the removal of certain frequency components in order to eliminate the noise components in the image. FIG. 7 shows one example of the relationship between the frequency component and the output during coring. In this drawing, frequency components in the range between a1 and a2 are removed. However, in actuality, because noise cannot be separated from the image signal, image signals are also removed during the coring process. Therefore, in order not to damage the image signal, the value of a2, which is the cut-off frequency, should be made small, but the value must be maintained at a certain value in order to eliminate the noise. However, where the amount of blur is set to be large in blur control, the noise components also become blurred and approach the low frequency range, enabling the value of a2 to be made small. Accordingly, as shown in FIG. 8, if the processing is changed such that the value of the cut-off frequency a2 becomes smaller as the amount of blur increases, the loss of image signals may be reduced and the impact of the noise components is mitigated.

‘Aperture control’ refers to an emphasis on the high-frequency components of the image in order to make the contour lines clear. FIG. 9 is a drawing showing the process of aperture control used by the digital camera of the present invention. The image signal input from the left is bifurcated (#601), and one of the signal parts passes through the LPF (Low-Pass Filter) so that the low-frequency components remain (#602). This signal is bifurcated once more (#603). By subtracting the low-frequency components from the input signal part obtained from bifurcation, only the high-frequency components remain (#604). These high-frequency components are subjected to coring (#605), and are amplified G times (#606). The low-frequency components, which were separated through bifurcation, are then added to the amplified signal part (#607).

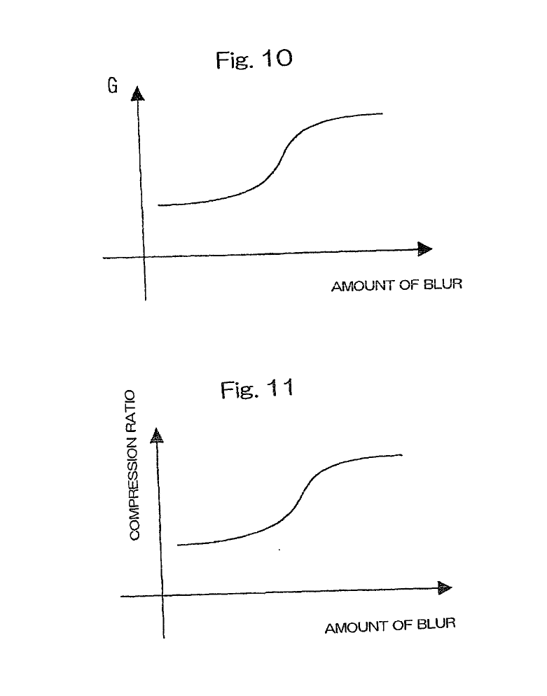

The high-frequency components of the image are emphasized through the above processing, and the image contour lines are made sharp. However, emphasis of the high-frequency components of the image also entails emphasis of the noise components. Therefore, in general, the amplification ratio G cannot be set very high. Nevertheless, where a large amount of blur is specified in blur control, the noise components also become blurred and approach the low frequency range, such that even if the amplification ratio G is increased, image noise does not become conspicuous. Accordingly, the processing is changed such that the amplification ratio G increases as the amount of blur increases, as shown in FIG. 10. Through this processing, a sharp image may be obtained without the noise components being emphasized.

Finally, the image compression unit 51 will be explained. Where a large amount of blur is specified during blur control, even if the compression ratio is large, there is minimal impact on image quality. Therefore, by changing the processing such that the compression ratio increases as the amount of blur increases, as shown in FIG. 11, a high compression ratio may be obtained while deterioration in image quality is prevented.

In the embodiment explained above, image compression, coring and aperture control were described as examples of processes other than blur control, but the present invention is not limited to such processes, and for example, the γ-value may be changed in accordance with the amount of blur when the blur-controlled image is subjected to γ-correction. Furthermore, the above example described a case in which all types of other processes, i.e., image compression, coring and aperture control, are changed in accordance with the amount of blur, but it suffices if the degree of processing is changed in accordance with the amount of blur in regard to at least one type of processing.

In addition, a case was described in which blur control and other processes are performed by a digital camera 1, which comprises an image sensing device, but it is also acceptable if blur control and other processes, such as image compression, carried out with regard to the multiple images captured by the image sensing device are performed by an image processing apparatus such as a computer, for example.

As explained above, using this embodiment, the degree of processing for processes other than blur control is changed in accordance with the amount of blur, and therefore processes other than blur control may be carried out successfully.

For example, by setting the image compression ratio to be high when the amount of blur is large, an image may be recorded using a high compression ratio without compromising image quality.

Alternatively, by reducing the number of frequency components removed during the coring process when the amount of blur is large, noise may be reduced with little loss of image signal.

Furthermore, using this embodiment, when the amount of blur is large, for example, image contour lines may be made sharp by increasing the amplification ratio, without causing image noise to become conspicuous.

Moreover, using this embodiment, a single-image sensing device may be used to obtain multiple images for blur control, prepare a blur-controlled image and perform processing to the prepared blur-controlled image in accordance with the amount of blur.

Although the present invention has been fully described by way of examples with reference to the accompanying drawings, it is to be noted that various change and modifications will be apparent to those skilled in the art. Therefore, unless otherwise such changes and modifications depart from the scope of the present invention, they should be construed as being including therein.

What is claimed is:

1. An image processing apparatus comprising:
a synthesizer for generating a blur controlled image with an adjusted blur amount from multiple images having different focal lengths;
an image processor for performing a process other than blur control on the blur-controlled image generated by the synthesizer; and
a changer for changing a degree of the process other than blur control in accordance with the amount of blur.

2. The image processing apparatus according to claim 1, wherein said image processor is an image compressor, and said changer changes an image compression ratio by the image compressor in accordance with the amount of blur.

3. The image processing apparatus according to claim 2, wherein said changer changes the image compression ratio such that the image compression ratio increases as the amount of blur increases.

4. The image processing apparatus according to claim 1, wherein said image processor is a coring processor, and said changer changes frequency components to be removed by the coring processor in accordance with the amount of blur.

5. The image processing apparatus according to claim 4, wherein said changer changes such that the value of the removed frequency becomes smaller as the amount of blur increases.

6. The image processing apparatus according to claim 1, wherein said image processor is a aperture controller, and said changer changes an amplification ratio by the aperture controller in accordance with the amount of blur.

7. The image processing apparatus according to claim 6, wherein said changer changes the amplification ratio such that the amplification ratio increases as the amount of blur increases.

8. The image processing apparatus according to claim 1, wherein said image processor is a gamma corrector, and said changer changes a value of the gamma correction by the gamma corrector in accordance with the amount of blur.

9. An image sensing device comprising:
an image sensor for capturing multiple images having different focal lengths;
a synthesizer for generating a blur controlled image with an adjusted blur amount from multiple images captured by the image sensor;
an image processor for performing a process other than blur control on the blur-controlled image generated by the synthesizer; and
a changer for changing a degree of the process other than blur control in accordance with the amount of blur.

10. The image sensing device according to claim 9, wherein said image processor is an image compressor, and said changer changes an image compression ratio by the image compressor in accordance with the amount of blur.

11. The image sensing device according to claim 10, wherein said changer changes the image compression ratio such that the image compression ratio increases as the amount of blur increases.

12. The image sensing device according to claim 9, wherein said image processor is a coring processor, and said changer changes frequency components to be removed by the coring processor in accordance with the amount of blur.

13. The image sensing device according to claim 12, wherein said changer changes such that the value of the removed frequency becomes smaller as the amount of blur increases.

14. The image sensing device according to claim 9, wherein said image processor is a aperture controller, and said changer changes an amplification ratio by the aperture controller in accordance with the amount of blur.

15. The image sensing device according to claim 14, wherein said changer changes the amplification ratio such that the amplification ratio increases as the amount of blur increases.

16. The image sensing device according to claim 9, wherein said image processor is a gamma corrector, and said changer changes a value of the gamma correction by the gamma corrector in accordance with the amount of blur.
